(19) United States
(12) Patent Application Publication
(10) Pub. No.: US 2024/0010567 A1
(43) Pub. Date: Jan. 11, 2024

(54) A CLASS OF MULTIPHASE RUBIDIUM TITANATE FUNCTIONAL CERAMIC MATERIALS AND PREPARATION METHOD THEREOF

(71) Applicants: GUANGZHOU GREATER BAY TECHNOLOGY CO., LTD, Guangzhou (CN); GUANGZHOU TUO XIN ENERGY TECHNOLOGY CO., LTD., Guangzhou (CN)

(72) Inventors: Xiangdong HUANG, Guangzhou (CN); Feng PEI, Guangzhou (CN); Sirui HUANG, Guangzhou (CN); Zhipeng HU, Guangzhou (CN); Zhuo WANG, Guangzhou (CN)

(21) Appl. No.: 18/037,744

(22) PCT Filed: Nov. 15, 2021
(86) PCT No.: PCT/CN2021/130707

§ 371 Date: May 18, 2023

(30) Foreign Application Priority Data
Nov. 19, 2020 (CN) 202011302322.3

(51) Int. Cl. C04B 35/46

(52) U.S. Cl. CPC C04B 35/46; C04B 2235/3232; C04B 2235/6562; C04B 2235/6565; C04B 2235/6567; C04B 2235/6583; C04B 2235/96

(57) ABSTRACT

A class of multiphase rubidium titanate functional ceramic materials is provided in this disclosure, the composition of which comprises phases of rubidium n-titanates with chemical formula of Rb₂TiₙO₂ₙ₊₁, that of titanium dioxide with chemical formula of TiO₂, and a small amount of optional dopant for the purpose of further improving or adjusting performance of the materials. The said materials are obtained by mixing the sources of rubidium, titanium and optional dopant to get a highly active fine-powdery precursor, and then by making heat-treatment in air of the precursor. The said materials possess unusual electrical and electrochemical properties, such as colossal permittivity up to the order of 10⁹ at room temperature accompanied by relatively low dielectric loss, excellent insulativity accompanied by high ionic conductivity up to 10⁻³ S/cm, have a broad application prospect in the fields like rechargeable high energy density storage devices, semiconductor devices and catalytic purification.

### TECHNICAL FIELD

This disclosure relates to a class of multiphase rubidium titanate functional ceramic materials having unusual electrical and electrochemical properties and method for preparing/manufacturing the materials thereof.

### BACKGROUND

Today, rechargeable electric energy storage (EES) devices are indispensable to human life, which are widely used in cellphones, laptops, remote control, wearable intelligent devices, electric vehicles and so on. Types of the EES devices mainly include electrochemical cells/batteries, capacitive energy storage devices and/or a combination of the two, and inductive energy storage devices that are not yet technically practicable.

Electro-chemical battery is represented by the widely used lithium batteries, whose volumetric and gravimetric energy densities are higher than other types of EES devices, reaching levels of from 250 to 700 Wh/L and from 100 to 300 Wh/kg, but these are only from 2.7% to 7.7% and from 0.77% to 2.1% of gasoline respectively, and the room for further improvement is limited. Besides, the safety related flammability, relatively low power density (charge and discharge rate), cycle life and weatherabilty, relatively high cost and so on, all these are still far away from what is expected from applications. Therefore, many efforts are continuously made to improve the lithium batteries, including the exploration of all-solid-state ones that avoid the use of electrolytic liquid, patent U.S. Pat. No. 10,249,911B2 of Toyota is one of the examples reflecting such efforts.

The representative of battery-capacitor hybrid devices is supercapacitor, and its performance falls between battery and dielectric capacitor. Its power density is from 10 to 60 times and its energy density is from 1/20 to ⅕ of that of lithium battery. There are still issues regarding safety and cost due to electrolytic liquid being still used.

Dielectric capacitor is a sort of all-solid-state physical energy storage devices with larger voltage window and advantages in power density, safety, weatherability, cycle life and cost. Its basic cell is a sandwich structure consisting of two thin conducting electrodes and a thin dielectric layer between them. Its stored electric energy is determined by the formula E=ε₀ε′SV²/2d, where ε₀ε′ S/d is its capacitance C (i.e. C=ε₀ε′ S/d), ε₀ is the permittivity (dielectric constant) of vacuum, ε′ is the relative permittivity of the dielectric layer, S is the effective area of the electrodes, d is the thickness of the dielectric layer, and V is the open circuit voltage between the electrodes. The so-called high dielectric (high-ε′) materials today have ε′≤10³ only, resulting in that energy density of dielectric capacitor is far lower than the electrochemical battery. Therefore, people continually try to improve it, besides by increasing S and V, lowering loss and d (as Multilayer Ceramic Capacitor MLCC does, but currently its highest energy density is about 1 Wh/L only), mainly by developing colossal dielectric materials of ε′>10³. Examples reflecting this trend include patents U.S. Pat. Nos. 10,239,792B2, 07,595,109B2 and CN106565234B etc., related to materials of colossal permittivity ε′ on the order of 10⁴ and capacitive EES systems based on which with energy density reportedly comparable to that of the lithium battery systems.

However, it is necessary to tackle the issues such as raising the colossal permittivity from today's ε′ of from about 10⁴ to 10⁵ by several orders more, so that the dielectric capacitor can raise its energy density by much the same orders, before it can truly challenge the current dominance of the lithium battery. In this regard, a significant improvement reflected by Federicci R. et al. (Federicci R. et al., Rb₂Ti₂O₅: superionic conductor with colossal dielectric constant, Physical Review Materials, 2017 1 (3), 1-6; and R. Federicci et al., The crystal structure of Rb₂Ti₂O₅, Structural Science Crystal Engineering Materials, 2017 B73, 1142-1150) is noteworthy: a type of rubidium dititanate ceramic material has been reported, which is characterized in that the final step of preparation process of the said material is annealing at about 400° C. in the absence of air (oxygen) condition; and, only by keeping the said material tested under strictly oxygen-free and dehumidified environmental conditions, some outstanding material characteristic parameters (in terms of electrics and electrochemistry) can be measured. These parameters include a colossal relative permittivity (ε′) up to the order of 10⁹, a high ionic conductivity circa 10⁻³ S/cm and a high electronic resistivity up to 10⁸ Ω·mm etc. However, once the too strict environmental requirements for material preparation and application are not met, properties of the said material will be drastically reduced to quite inferior levels, resulting in mal applicability. These shortcomings need to be overcome, and the invention here is going to make an effective breakthrough in this aspect.

### SUMMARY

This invention provides a class of multiphase rubidium titanate functional ceramic (hereinafter referred to as MRTFC) materials, containing mainly rubidium n-titanate (Rb₂TiₙO₂ₙ₊₁) phase(s), which has unusual electrical and electrochemical properties superior to the prior arts in natural ambient conditions, such as colossal permittivity ε′ up to the order of 10⁹ at room temperature with relatively low dielectric loss, excellent insulativity with ionic conductivity up to the order of 10⁻³ S/cm; in addition to providing colossal dielectric solutions for high energy density storages. It also has great application potential in solid electrolytes, memory storage units, semi-conductive electronic devices, catalytic purification and other fields. The key to the preparation of such high-performance MRTFC materials lies in the preparation of highly active fine powdery precursor and/or the subsequent heat-treatment (firing/calcination etc.) processes for MRTFC powders and articles. To this end, the invention also provides methods for preparing the materials, in particular methods suitable for industrialized preparations.

The class of MRTFC materials comprises rubidium n-titanate phase(s) chemically formulated as Rb₂TiₙO2ₙ₊₁ or Rb₂O·nTiO₂ and titanium dioxide phase(s) chemically formulated as TiO₂ (one or more among anatase, rutile, brookite or amorphous type), where n is single- or multi-valued real number no lower than 1; preferably n is from 1 to 12 including all values and subranges therebetween, for example, 1, 2, 3, 4, 5, 6, 7, 8, 9, 10, 11 and 12; more preferably n is from 1.9 to 6.

The value of n in the Rb₂TiₙO₂ₙ₊₁ is ranged from 1 to 12, which means that the rubidium titanate phase(s) in the present invention may comprise one or more compounds having the formula Rb₂TiₙO₂ₙ₊₁. For example, the compound may be Rb₂Ti₂O₅, Rb₂Ti₄O₉, Rb₂Ti₆O₁₃, etc. Meanwhile, the multiphase functional ceramic materials may further contain an amount of titanium dioxide to optimize the material properties and reduce raw material costs as rubidium salts are largely more expensive than that of other raw materials due to its scarcity in the Earth's crust.

Optionally, the said MRTFC materials may further comprises one or more doping elements (dopants) selected from a group consisting of niobium, indium, yttrium, bismuth, lithium, potassium, sodium and cobalt in small amount for property adjustment or improvement.

Preferably, in the said MRTFC materials, the ratio of rubidium n-titanate phase(s) to the material total mass is from 45 wt % to 99 wt %, including all values and subranges therebetween, for example, 50, 55, 60, 65, 70, 75, 80, 85, 90, 95 and 98 wt %. The ratio of titanium dioxide phase(s) to the material total mass is more preferably from 1 wt % to 55 wt %, including all values and subranges therebetween, for example, 1, 2, 3, 4, 5, 6, 7, 8, 9, 10, 15, 20, 25, 30, 35, 40, 45, 50 wt %.

Preferably, in the said MRTFC materials, the ratio of the sum of optional dopants to the material total mass is from zero to 2 wt %, including all values and subranges therebetween, for example, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8 and 1.9 wt %.

Preferably, the said MRTFC materials have at least one of the following parameters: (i) a colossal static permittivity on the order of from 10⁸ to 10⁹; (ii) an electronic resistivity on the order of 10⁸ Ω·mm or more; (iii) an ionic conductivity on the order of 10⁻³ S/cm; and/or (iv) a quasi-static dielectric loss of no higher than one.

This invention further provides the preparation methods of the said MRTFC materials comprise a series of processes in which rubidium source, titanium source and optional dopant source are used to prepare fine and dry powdery mixture as a highly active precursor, and then get calcined (fired) into ceramic powder or articles at a temperature of from 450° C. to 1200° C.

The rubidium source of the said MRTFC precursor may be a compound that produces rubidium oxide by heating, including rubidium oxide, rubidium carbonate, rubidium hydroxide, rubidium nitrate and rubidium sulfate; preferably rubidium carbonate.

The titanium source of the said MRTFC precursor may be a compound containing titanium oxide, including titanium monoxide, titanium dioxide, wet filter cake of titanium hydroxide, and hydrated titanium dioxide, and can be metal titanium and titanium hydride; preferably titanium dioxide.

The optional dopant source of the said MRTFC precursor may be one or more selected from a group consisting of carbonate, nitrate, sulfate, oxide and hydroxide containing one or more dopant elements.

The mixing ratio between titanium and rubidium sources is based on the expected molar ratio of Rb:Ti=2:n according to Rb₂O·nTiO₂, but may be fine-tuned within a certain range. Considering the factors like rubidium volatilization loss in the heat treatment process, a scheme with rubidium source a little more and/or titanium source a little less may normally be chosen.

The said MRTFC fine powdery precursor may be prepared by dry synthetic methods such as solid phase mixing method and mechanical-chemical synthetic method, or by liquid and/or gas phase wet synthetic methods such as chemical deposition-precipitation method, hydrothermal method and sol-gel method. The mechanical-chemical synthetic method is preferably to use, which is conducive to large-scale industrialization and low cost preparation of the highly reactive powdery precursor, and the rubidium n-titanate phase(s) after calcination/firing still possess(s) high reactivity.

The calcination/firing process for the said MRTFC materials may be as follows: raising the temperature to a temperature of from 700° C. to 1200° C. at a heating rate of from 3° C./min to 10° C./min, holding for one hour to six hours, and then cooling to room temperature.

The calcining/firing process for the said MRTFC materials may also be as follows: the temperature rises from room temperature to a temperature of from 200° C. to 400° C. at a rate of from 3° C./min to 10° C./min, and then holds for one to four hours; then rises to a temperature of from 550° C. to 650° C. at a rate of from 3° C./min to 10° C./min, and then holds for 0.5 hour to four hours; then rises to a temperature of from 800° C. to 1200° C. at a rate of from 3° C./min to 10° C./min, and then holds for one hour to six hours; and then decreases to a temperature of from 900° C. to 700° C. at a rate of from 1° C./hour to 20° C./hour, followed by rapid decreasing to room temperature.

The rubidium n-titanate phase(s) of the calcined/fired MRTFC powder based on the precursor prepared by dry or wet methods, have a n-value approximating the expected one; but usually there also coexist certain proportion of rubidium titanates with n-value different from the expected one. The proportion of titanium dioxide phase(s) also varies within a certain range. In case there are needs to adjust the compound's phases in the application, such as adjusting the material's Rb-Ti phase ratio and making the rubidium n-titanate phase(s) shift to the desired (single) n value, several practical approaches for phase adjustment are also provided by this invention, including the dry approach to raise rubidium content, the (acid pickling dilution) wet approach to lower rubidium content, and the approach to raise titanium dioxide content, illustrated further with the corresponding examples.

The dry approach to increase Rb content ratio: an appropriate amount of rubidium carbonate or other Rb source to be newly added is evenly mixed into the highly reactive MRTFC powder obtained by previous heat treatment, and then the mixture is taken to a secondary firing at a temperature lower than the first heat treatment. The operations include: content of TiO₂ in the MRTFC powder is determined by the well-established and effective methods, such as XRD quantitative analysis→based on the target molar ratio of Rb:Ti=2:n in rubidium n-titanate, the new increment of Rb source needed to convert all or a given proportion (e.g. ½) of the TiO₂ existing in the MRTFC powder into the expected rubidium n-titanate is calculated out→the newly added Rb source is mixed well with the MRTFC powder→experience basic steps of secondary firing for 0.5 hour to two hours at a temperature of from 450° C. to 750° C. and so on→achieve the goals, including to raise Rb content ratio in the final product, lower down n-value of the rubidium n-titanate phase(s) and make it approach the targeted (single) n-value, etc.

The wet approach to decrease Rb content ratio: the fired highly reactive MRTFC powder is acid pickled to make the Rb components dissolved out in appropriate amount, and then the obtained solid powder is taken to a secondary firing at a temperature lower than the first firing. There is no special limit on the acid solution of pickling treatment, which may be inorganic acid like sulfuric, hydrochloric and nitric acid or organic acid like acetic acid and their combination, preferably sulfuric acid or nitric acid. The operations include: preparation of a specific mass fraction (such as 15 wt % of the MRTFC powder alkaline aqueous slurry→gradually add certain amount and concentration of acid solution to the slurry and mix, the pH of the slurry will approach the pH value corresponding to the target n-value indicated by the pH-n curve or its fitting formula (see FIG. 8 as an example), which is obtained in advance in well-known ways such as experiment→the slurry is filtered, separated and dehydrated→experience basic steps of secondary firing for 0.5 hour to two hours at a temperature of from 450° C. to 750° C. and so on→achieve the goals, including to reduce Rb content ratio in the final product, raise n-value of the rubidium n-titanate phase(s) and make it approach to the targeted (single) n-value, etc.

The approach to raise TiO₂ content ratio: certain amount of TiO₂ ceramic powder (ex. ceramic grade titanium dioxide) determined in advance according to the well-known ways, may be added to the fired highly reactive MRTFC powder and mixed evenly, so as to raise the ratio of TiO₂ phase(s).

Compared to the prior art, the application of the MRTFC materials of the present invention will produce some prominent beneficial effects. For example in principle, inheriting the alternating laminated or wound structure of the multilayer thin film dielectric capacitors, but just replacing the existing dielectric materials with the MRTFC materials of colossal permittivity (at least from 3 to 6 orders of magnitude higher) of this invention, it is expected to form a rechargeable solid-state energy storage device with colossal specific capacitance and super-high energy storage density, while carries over the original characteristics like high charge/discharge rate, high safety, long cycle life and low cost, and even to represent a strong challenge to lithium battery.

### BRIEF DESCRIPTION OF DRAWINGS

The features and advantages of the invention will become further apparent by reading a detailed description of the exemplary examples in the following sections, and by reviewing the attached drawings, in which:

FIG. 1 shows the thermogravimetric (TG) curve comparison of powdery precursors obtained by manual grinding and mechanical-chemical synthesis.

FIG. 2 is a scanning electron microscopy (SEM) image of the product obtained from the Example 1.

FIG. 3 is an X-ray diffraction (XRD) image of the product obtained from the Example 1.

FIG. 4 is a SEM image of the product obtained from an Example 2.

FIG. 5 is an XRD image of the product obtained from the Example 2.

FIG. 6 is a SEM image of the product obtained from an Example 3.

FIG. 7 is an XRD image of the product obtained from the Example 3.

FIG. 8 is an example of pH-n curve and its fitting formula used in the wet (acid dilution) method, obtained according to the known experimental method (by carrying on pickling experiments of a number of specific standard samples of MRTFC powder to get the pH values of their corresponding aqueous slurries, combined with XRD measurement of the samples to get their n-values, so as to drawn the curve and fit it).

### DETAILED DESCRIPTION

In order to make the technical solutions of the invention easy to understand, a more detailed description and explanation of the invention are given below in combination with the examples and the attached drawings. However, the invention is not limited to the following examples, and any alteration or modification of the technical ideas derived from the invention which can be easily deduced by a person familiar with the relevant technical field shall fall within the scope of the patent right for the protection claimed by the invention.

### EXAMPLE 1

### Preparation of MRTFC Powder by Mechanical-Chemical Synthesis and Solid-Phase Firing

### Step 1. Preparation of Dry Fine-Powdery Precursor

According to the stoichiometric molar ratio Ti:Rb of about n:2 in the chemical formula Rb₂TiₙO₂ₙ₊₁ (in this case n is taken to be 2), an appropriate amount of dry titanium dioxide (TiO₂) and rubidium carbonate (Rb₂CO₃) powders were separately taken as titanium and rubidium sources; the error of actual ratio between the two was controlled within 5%. After preliminarily mixing the two sources, the mixture was put in a vibrating mill further mechanically and chemically crushed/mixed for 30 minutes to form the precursor.

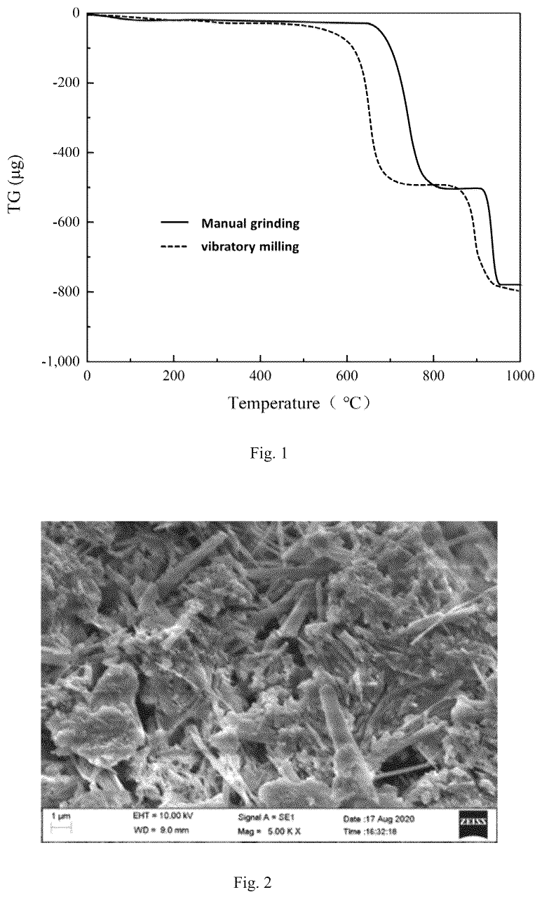

FIG. 1 is the TGA (thermo-gravimetric analysis) curve of the precursor obtained by the above mentioned method and compared with the TGA curve of the referential one obtained by grinding and mixing manually for 30 minutes. As can be seen from the figure, the temperature at which the pyrolysis and weight loss began is significantly lower for the precursor obtained by mechanical-chemical grinding and mixing in vibrating mill than that for the referential one, indicating that The former has higher reactivity than the latter, which is beneficial to the subsequent solid phase firing thermal reaction and energy saving.

### Step 2. Ceramic Powder Firing

An appropriate amount of powdery precursor obtained according to the step 1 was put into a crucible and placed in a heat treatment furnace, and fired in air at 780° C. for 4 hours.

When the temperature was lowered close to the ambient temperature, the produced ceramic powder was taken out and isolated in a controlled atmosphere (such as in a glove box in an argon environment), because the product has a strong hygroscopicity.

### Step 3. Material Tests of the Ceramic Powder

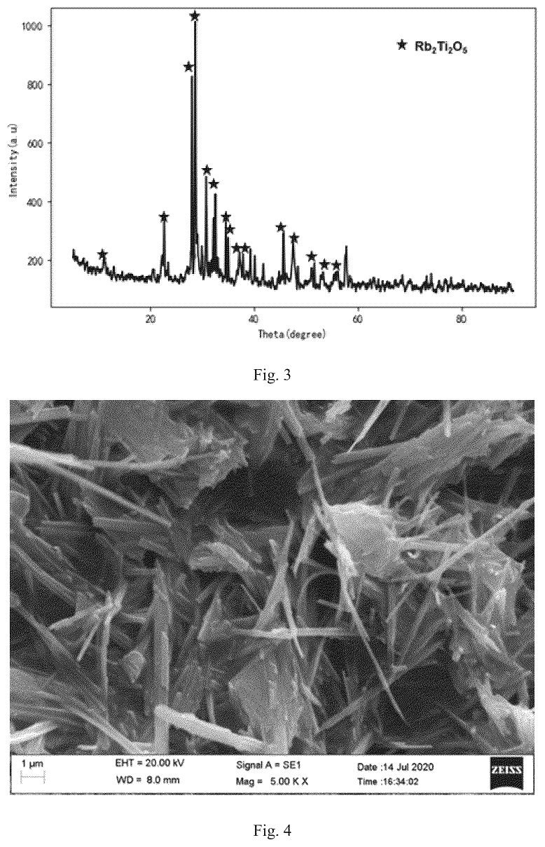

Scanning electron microscopy (SEM) of the product prepared in this Example is shown in FIG. 2. It can be seen that a large number of whisker crystals of submicron to nanoscale diameter is formed microstructurally. The X-ray diffraction (XRD) diagram of the product is shown in FIG. 3, indicating that its main component is rubidium dititanate Rb₂Ti₂O₅, accounting for about 95 wt %, and in addition, there is about 5 wt % titanium dioxide.

The main test results of relevant electrical/electrochemical parameters of the material prepared in this Example are as follows: quasi-static permittivity=2.89×10⁸, ultra-low frequency AC dielectric loss=0.79, electronic resistivity=7.7×10⁸ Ω·mm, and ionic conductivity=3.2×10⁻³ S/cm.

### EXAMPLE 2

### Preparation of MRTFC Powder by Liquid-Phase Synthesis and Solid-Phase Firing

### Step 1. Preparation of Dry Fine-Powdery Precursor

According to the stoichiometric molar ratio Ti:Rb of about n:2 in the chemical formula Rb₂TiₙO₂ₙ₊₁ (in this case n is taken to be 4), an appropriate amount of dry titanium dioxide (TiO₂) and rubidium carbonate (Rb₂CO₃) powders were separately taken as titanium and rubidium sources with the error of actual ratio between the two being controlled within 5%, and were put in the flask, to which deionized water 4 times weight as the titanium dioxide was added and mixed evenly. The solution was concentrated by an evaporator, dried to solidify, and then ground into powder to obtain the precursor.

### Step 2. Ceramic Powder Firing

An appropriate amount of powdery precursor obtained according to the step 1 was put into a crucible and placed in a heat treatment furnace, and fired in air at 870° C. for 1.5 hours.

When the temperature was lowered close to the ambient temperature, the produced ceramic powder was taken out and put in a glove box in an argon environment to avoid hygroscopicity.

### Step 3. Material Tests of the Ceramic Powder

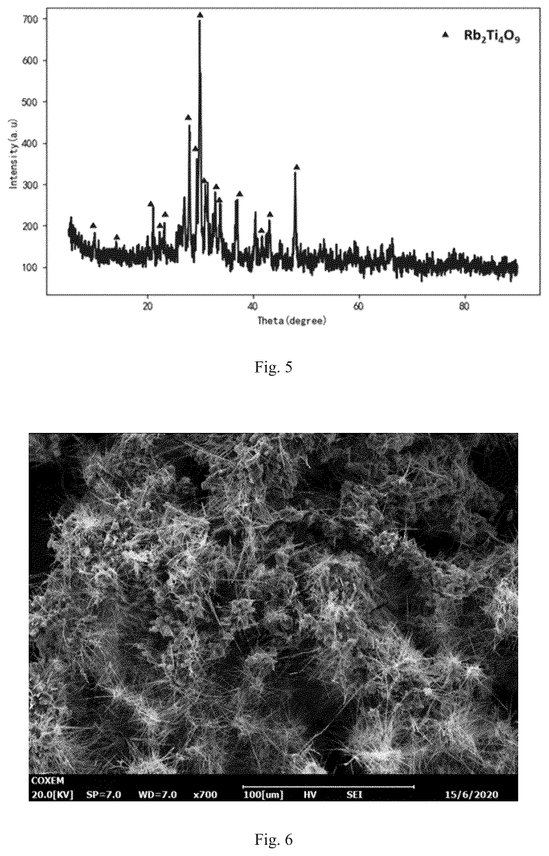

SEM image of the product obtained in this example is shown in FIG. 4. It is seen that a large number of whisker crystals of submicron to nanoscale diameter were formed microstructurally. The XRD diagram of the product is shown in FIG. 5, indicating that its main component is rubidium tetratitanate Rb₂Ti₄O₉, accounting for about 85 wt %, and in addition, there is about 15 wt % titanium dioxide.

The main test results of relevant electrical/electrochemical parameters of the material prepared in this example are as follows: quasi-static permittivity=2.39×10⁹, ultra-low frequency AC dielectric loss=0. 88, electronic resistivity=2.3×10⁸ Ω·mm, and ionic conductivity=3.1×10⁻³ S/cm.

### EXAMPLE 3

### Preparation of MRTFC Powder by Solid Phase Mixing and Firing Synthesis

### Step 1. Preparation of Precursor

Titanium oxide (TiO₂) and rubidium carbonate (Rb₂CO₃) powders were used as titanium source and rubidium source respectively, roasted at 100° C. for 24 hours to make them completely dehydrated. According to the stoichiometric molar ratio Ti:Rb of about n:2 in the chemical formula Rb₂TiₙO₂ₙ₊₁ (in this case n is taken to be 3), the appropriate amount of titanium source and rubidium source were weighed respectively with the error of actual ratio between the two being controlled within 5%. The two were placed together in an agate mortar and ground for 20 minutes, the powder obtained was pressed by a 10-ton press for 5 minutes to obtain the precursor.

### Step 2. Ceramic Powder Firing

The obtained precursor was put into the crucible and placed in the heat treatment furnace, the following processes were carried out in air for heat treatment: to heat up to 315° C. and hold for 2 hours→heat up to 600° C. and hold for 0.5 hour→heat up to 930° C. and hold for 3 hours (temperature and time may be adjusted to optimize the quality of the obtained crystal)→lower down the temperature to 880° C. at a slow rate of about 5° C./hour→stop heating and quickly cool down to the room temperature. The product obtained was placed in a glove box in an argon gas environment to avoid moisture absorption.

Because the firing temperature of this method is higher, the product after partially or totally melting or sintering is easy to be bonded to the crucible wall and relatively troublesome to take out; and the product is lumpy, the subsequent crushing and grinding are needed to make it powdery.

### Step 3. Tests of the Ceramic Material

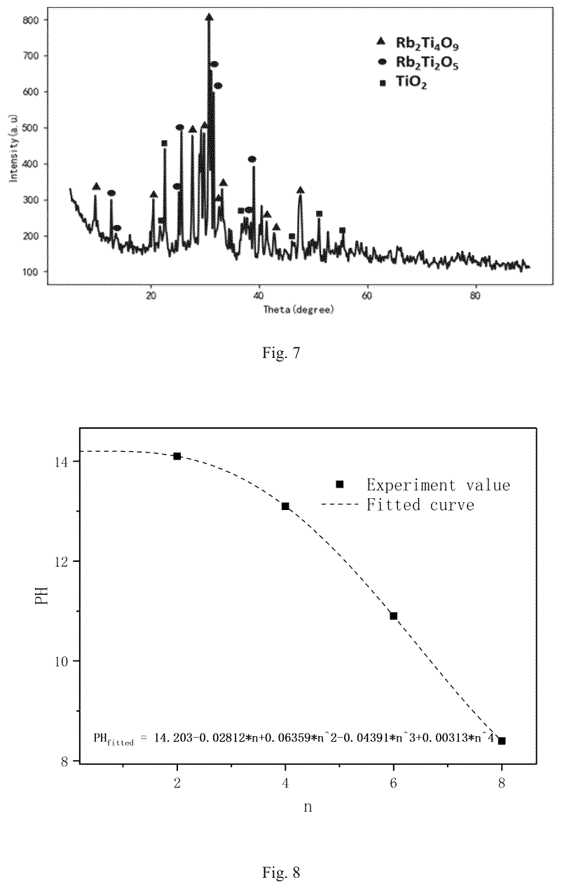

SEM image of the product obtained in this example was shown in FIG. 6. It is seen that a large number of whisker crystals of submicron to nanoscale diameter were formed microstructurally. The corresponding XRD analysis (FIG. 7) indicates that the main components of the obtained product include 15 wt % of titanium dioxide, 65 wt % of multiphase rubidium n-titanate (23 wt % of rubidium dititanate Rb₂Ti₂O₅ and 42 wt % of rubidium tetratitanate Rb₂Ti₄O₉). This reflects the following essences: rubidium trititanate as a reaction intermediate is apt to convert into a mixture of rubidium dititanate and tetratitanate of certain proportion ratio; and that when the n-value is neither 1 nor an even number, the material is usually a sort of multiphase rubidium n-titanates.

The main test results of relevant electrical/electrochemical parameters of the material prepared in this example are as follows: quasi-static permittivity=2.66×10⁹, ultra-low frequency AC dielectric loss=0.91, electronic resistivity=1.5×10⁸ Ω·mm, and ionic conductivity=3.0×10⁻³ S/cm.

### EXAMPLE 4

### Wet Approach to Lower Rb Content Ratio in the MRTFC Powder

An appropriate amount of MRTFC powder with rubidium dititanate as the main componet made according to Example 1 was used to prepare 500 ml aqueous slurry of 15 wt %. An appropriate amount of 70 wt % nitric acid (HNO₃) aqueous solution was then gradually added to it and stirred for 1 hour until the pH value was adjusted to 13.1. The slurry was filtered, separated and dried. The dry extract was then fired in a heat treatment furnace at 550° C. for 1 hour. The fired material was made into ceramic powder A with appropriate particle size by using the grinding method.

Another appropriate amount of MRTFC powder made according to Example 1 was used to prepare 500 ml aqueous slurry of 15 wt %. An appropriate amount of 70 wt % HNO₃ aqueous solution was then gradually added to it and stirred for 1 hour until the pH value was adjusted to 10.9. The slurry was filtered, separated, and dried. The dried extract was then fired in a heat treatment furnace at 550° C. for one hour. The fired material was made into ceramic powder B with appropriate particle size by using the grinding method.

FIG. 8 shows the pH-n value relationship, fitting formula and fitting curve determined in advance according to the known experimental method. According to FIG. 8, the ceramic powder A is expected to be mainly quasi single-phase powder composed of rubidium tetratitanate Rb₂Ti₄O₉ and other components close to it (n is about 4), and the ceramic powder B is expected to be mainly quasi single-phase powder composed of rubidium hexatitanate Rb₂Ti₆O₁₃ and other components close to it (n is about 6).

The XRD analysis results show that, the ratio of rubidium tetratitanate in powder A is 94 wt %, and that of rubidium hexatitanate in powder B is 93 wt %. The measured results are highly consistent with expectations, and practicability of the wet (pickling dilution) phase-control method is thus confirmed.

### EXAMPLE 5

### Dry Approach to Raise Rb Content Ratio in the MRTFC Powder

The MRTFC powder prepared of Example 3 was used. According to the XRD analysis result as showed above, the MRTFC powder contains 23 wt % rubidium dititanate Rb₂Ti₂O₅ (the expected phase in this example), 42 wt % rubidium tetratitanate Rb₂Ti₄O₉ and 35 wt % titanium dioxide TiO₂. Now it is intended to convert the MRTFC powder of Example 3 into a ceramic powder of quasi single phase rubidium dititanate (n=2), i.e., rubidium dititanate as the main component.

An appropriate amount of powder F grams obtained from Example 3 was weighed, in which the TiO₂ content was known to be T′=F×35 wt %. Since converting rubidium tetratitanate to rubidium dititanate will also release a certain amount of TiO₂ (rubidium tetratitanate in F is 42 wt %, if they were totally converted to rubidium dititanate, the TiO₂ released would figure out as F×13.2 wt %), that is, the available TiO₂ source content in F is T=F×(35+13.2) wt %=F×48.2 wt % grams in fact. According to the basic molar ratio Rb:Ti=2:n (being equal to 1:1), the molar mass of Ti in T grams of TiO₂ should be equal to (or slightly less than) the molar mass of the Rb element to be added, which is enough to support the newly added rubidium source (ex. rubidium carbonate) weight estimation.

The F grams of MRTFC powder of Example 3 and the rubidium carbonate newly added were evenly mixed, put into a crucible and placed in a heat treatment furnace, and fired again at 580° C. for 0.8 hour. After cooling down, the product was taken out for further crushing and grinding, the MRTFC powder after phase regulation was thus obtained.

XRD analysis of the obtained product shows the content of Rb₂Ti₂O₅ is 90.5 wt % and that of TiO₂ is 9.5 wt %, which are in line with the expected results and confirm the practicability of the phase-adjusting dry approach for increasing Rb content.

### EXAMPLE 6

### Niobium-Doped MRTFC Material

### Step 1. Preparation of Precursor

Rubidium hydroxide as rubidium source, titanium dioxide as titanium source and niobium pentaoxide as dopant source were weighed at a molar ratio of 1.8:1.5:0.07 and placed in a vibrating mill and ground for 45 minutes until the system was uniform, the powdery precursor was thus obtained.

### Step 2. Ceramic Powder Firing

An appropriate amount of the obtained precursor was put into the crucible and placed in the heat treatment furnace, fired in air at 750° C. for 4 hours, and taken out after cooled down to ambient temperature. The obtained product was kept in a glove box filled with argon gas to avoid moisture absorption.

### Step 3. Tests of the Ceramic Material

XRD analysis shows that the main component of the product is Rb_{1.9}Ti_{1.9}Nb_{0.1}O₅, and the content is 87.5 wt %. SEM image shows that there are also a large number of whiskers with sub-micron to nanoscale diameters.

The main test results of relevant electrical/electrochemical parameters of the material prepared in this example are as follows: quasi-static permittivity=1.32×10⁹, ultra-low frequency AC dielectric loss=0.79, electronic resistivity=1.8×10⁸ Ω·mm, and ionic conductivity=3.0×10⁻³ S/cm.

### EXAMPLE 7

### Preparation of MRTFC Powder by Solid Phase Mixing and Firing Synthesis

### Step 1. Preparation of Precursor

According to the stoichiometric molar ratio Ti:Rb of abaout n:2 in the chemical formula Rb₂TiₙO₂ₙ₊₁ (in this case n is taken to be 12), the appropriate amount of titanium source (TiO₂) and rubidium source (Rb₂CO₃) were weighed respectively with the error of actual ratio between the two being controlled within 5%, and mixed until the system was uniform.

### Step 2. Ceramic Powder Firing

The obtained precursor was put into the crucible and placed in the heat treatment furnace, fired in air at 1120° C. for 4 hours, and taken out after cooled down to ambient temperature. The obtained product was kept in a glove box filled with argon gas to avoid moisture absorption.

### Step 3. Tests of the Ceramic Material

The main test results of relevant electrical/electrochemical parameters of the material prepared in this example 7 are as follows: quasi-static permittivity=1.02×10⁸, ultra-low frequency AC dielectric loss=0.59, electronic resistivity=9.7×10⁹ Ω·mm, and ionic conductivity=1.03×10⁻³ S/cm.

While it has been shown and described several examples in accordance with the invention and use thereof, it is understood that the same is not limited thereto, but is susceptible to many changes and modifications to one possessing ordinary skill in the art, and therefore we do not wish to be limited to the details shown and described herein, but intend to cover all such modifications as are encompassed by the scope of the appended claims.

What is claimed is:

1. A class of multiphase rubidium titanate functional ceramic materials, wherein the said multiphase rubidium titanate functional ceramic materials comprise rubidium n-titanate phase(s) with chemical formula Rb₂TiₙO₂ₙ₊₁, and titanium dioxide phase(s) with chemical formula of TiO₂; the ratio of the rubidium n-titanate phase(s) is from 45 wt % to 99 wt %, and the ratio of titanium dioxide phase(s) is from 1 wt % to 55 wt %, based on the total mass of said multiphase rubidium titanate functional ceramic materials; the value of n in the chemical formula of the rubidium n-titanate phase(s) is from 1 to 12; the multiphase functional ceramic material is prepared in air.

2. The class of multiphase rubidium titanate functional ceramic materials according to claim 1, further comprising one or more dopant elements selected from the group consisting of niobium, indium, yttrium, bismuth, lithium, potassium, sodium and cobalt.

3. The class of multiphase rubidium titanate functional ceramic materials according to claim 2, wherein the ratio of the one or more dopant elements is from zero to 2 wt %, based on the total mass of said multiphase rubidium titanate functional ceramic materials.

4. The class of multiphase rubidium titanate functional ceramic materials according to claim 1, wherein n is from 1 to 6 in the chemical formula of the rubidium n-titanate phase(s).

5. The class of multiphase rubidium titanate functional ceramic materials according to claim 4, wherein n is from 1.9 to 6 in the chemical formula of the rubidium n-titanate phase(s).

6. The class of multiphase rubidium titanate functional ceramic materials according to claim 1, wherein said multiphase rubidium titanate functional ceramic materials have at least one of following material characteristic parameters: (i) static permittivity up to the order of from 10⁸ to 10⁹, (ii) electronic resistivity on the order of 10⁸ Ω·mm or more, (iii) ionic conductivity on the order of 10⁻³ S/cm, and (iv) quasi-static dielectric loss of no higher than one.

7. A method for preparing the class of multiphase rubidium titanate functional ceramic materials as claimed in claim 1, including:
(1) mixing rubidium source, titanium source and optional dopant source to prepare a powdery precursor;
(2) firing the powdery precursor in air at a temperature of from 450° C. to 1200° C. to turn it into said multiphase functional ceramic material.

8. The method according to claim 7, wherein said rubidium source includes one or more components selected from the group consisting of rubidium oxide, rubidium carbonate, rubidium hydroxide, rubidium nitrate and rubidium sulfate; said titanium source includes one or more components selected from the group consisting of titanium oxide, titanium dioxide, titanium hydroxide, titanium metal and titanium hydride; said dopant source includes one or more components selected from the group consisting of the carbonate, nitrate, sulfate, oxide and hydroxide of the dopant element.

9. The method according to claim 7, wherein the preparation of the powdery precursor adopts at least one from the solid-phase mixing method, mechanical-chemical synthesis method, chemical precipitation method, hydrothermal method and sol-gel method; the weight ratio of the rubidium source and the titanium source is adjusted based on the expected molar ratio Rb:Ti=2:n of the rubidium n-titanates Rb₂TiₙO₂ₙ₊₁.

10. The method according to claim 7, wherein the firing process of said ceramic material is to heat said powdery precursor up to a temperature from 700° C. to 1200° C. at a heating rate of from 3° C./min to 10° C./min, hold for from 1 hour to 6 hours, and then cool down to room temperature.

11. The method according to claim 7, wherein the firing process of said ceramic material is to heat said powdery precursor up to a temperature of from 200° C. to 400° C. at a heating rate of from 3° C./min to 10° C./min, hold for from 1 hour to 4 hours, then raise the temperature up to a temperature of from 550° C. to 650° C. at a heating rate of from 3° C./min to 10° C./min , hold for from 0.5 hour to 4 hours, and then raise the temperature up to a temperature of from 800° C. to 1200° C. at a heating rate of from 3° C./min to 10° C./min, hold for from 1 hour to 6 hours; then cool down to a temperature from 900° C. to 700° C. at a cooling rate of from 1° C./hour to 20° C./hour, and then cool to room temperature.

12. The method according to claim 7, wherein the method further includes a step of adjusting the composition of the prepared multiphase rubidium titanate functional ceramic materials by one or more of following approaches: (1) an approach for increasing the content of titanium dioxide; (2) an dry-approach for increasing the content of rubidium; or (3) a wet pickling dilution approach for decreasing the content of rubidium in the prepared multiphase rubidium titanate functional ceramic materials, so as to achieve a goal of compound's phase composition adjustment of the prepared multiphase rubidium titanate functional ceramic materials.

13. The method according to claim 12, wherein the approach for increasing the content of titanium dioxide includes: a certain amount of additionally required TiO₂ ceramic powder determined by the known method is added to a given amount of the already prepared multiphase rubidium titanate functional ceramic powdery material and then mixed evenly, so as to achieve the goal of increasing the proportion of titanium dioxide in the multiphase rubidium titanate functional ceramic material;

14. The method according to claim 12, wherein the dry-approach for increasing the content of rubidium includes: a certain amount of additionally required rubidium source determined by the known method added to a given amount of the already prepared multiphase rubidium titanate functional ceramic powdery material and made into an uniform mixture, which is then fired at a temperature from 450° C. to 750° C. for from 0.5 hour to 2 hours, so as to achieve the goals of increasing rubidium content, of making the n-value of the rubidium n-titanate phase(s) in the multiphase rubidium titanate functional ceramic material reduce and approach a lower and single expected value.

15. The method according to claim 12, wherein the wet pickling dilution approach for decreasing the content of rubidium includes: the obtained MRTFC powder by firing is prepared into a water slurry of from 10 to 50 wt % solid weight, to which a certain concentration of acid liquid is added to make its pH value reduced and approached to the specific value determined in advance according to the publically known method such as experiment; the slurry is filtered, dried, and then fired at a temperature of from 450° C. to 750° C. for from 0.5 hour 2 hours, so as to achieve the goals of decreasing rubidium content, of making the n value of the rubidium n-titanate phase(s) in the multiphase rubidium titanate functional ceramic material raise and approach a higher single expected value.

16. The method according to claim 15, wherein the acid liquid used in the wet pickling dilution approach is one or more acids selected from the group consisting of sulfuric acid, hydrochloric acid, phosphoric acid, nitric acid and acetic acid solutions.

17. The class of multiphase rubidium titanate functional ceramic materials according to claim 2, wherein said multiphase rubidium titanate functional ceramic materials have at least one of following material characteristic parameters: (i) static permittivity up to the order of from 10⁸ to 10⁹, (ii) electronic resistivity on the order of 10⁸ Ω·mm or more, (iii) ionic conductivity on the order of 10⁻³ S/cm, and (iv) quasi-static dielectric loss of no higher than one.

18. The class of multiphase rubidium titanate functional ceramic materials according to claim 3, wherein said multiphase rubidium titanate functional ceramic materials have at least one of following material characteristic parameters: (i) static permittivity up to the order of from 10⁸ to 10⁹, (ii) electronic resistivity on the order of 10⁸ Ω·mm or more, (iii) ionic conductivity on the order of 10⁻³ S/cm, and (iv) quasi-static dielectric loss of no higher than one.

19. The method according to claim 7, wherein the class of multiphase rubidium titanate functional ceramic materials further comprises one or more dopant elements selected from the group consisting of niobium, indium, yttrium, bismuth, lithium, potassium, sodium and cobalt.

20. The method according to claim 19, wherein based on the total mass of the multiphase rubidium titanate functional ceramic materials, the ratio of the one or more dopant elements is from zero to 2 wt %.
